(19) United States
(12) Patent Application Publication
(10) Pub. No.: US 2002/0181501 A1
(43) Pub. Date: Dec. 5, 2002

(54) System and method for machine to machine communication

(76) Inventors: Michael P. Nova, Del Mar, CA (US); Gino Innocenti, Ramona, CA (US); Donald W. Gillies, San Diego, CA (US)

Correspondence Address: LYON & LYON LLP, 633 WEST FIFTH STREET, SUITE 4700, LOS ANGELES, CA, 90071, US

(21) Appl. No.: 10/098,882

(22) Filed: Mar. 13, 2002

Related U.S. Application Data
(63) Continuation-in-part of application No. 09/522,526, filed on Mar. 10, 2000, now abandoned.
(63) Continuation-in-part of application No. 09/268,079, filed on Mar. 12, 1999, now abandoned.

(51) Int. Cl. H04J 3/16

(52) U.S. Cl. 370/467; 370/356

(57) ABSTRACT

A device for providing machine to machine communication over a communication network is presented. The device may be implemented as an ASIC, sea of gates, or mask programmed CPU. The device resides directly in the communication path between the processor and the physical layer of the host machine. Circuitry and embedded software perform the functions of data traffic management (communications and routing), application hosting, network architecture monitoring and diagnostics, LAN operations, security, machine diagnostics and location mapping. The device is adaptable to communicate over wired and wireless networks employing any of the various available transport media including phone, bluetooth, Ethernet, and 802.11 a/b, just to name a few.

### RELATED APPLICATION

The present application is a continuation-in-part of co-pending U.S. patent application Ser. No. 09/522,526, entitled SYSTEMS AND METHODS FOR NETWORK BASED SENSING AND DISTRIBUTED SENSOR, DATA AND MEMORY MANAGEMENT, of concurrent ownership, attorney docket number 251/202 filed on Mar. 10, 2000, which is incorporated herein by reference in its entirety.

### BACKGROUND OF THE INVENTION

1. Field of the Invention

The present invention generally relates to operating systems for network enabled devices and more particularly relates to operating systems having dynamic data routing protocols for decentralized network enabled devices.

2. Related Art

Various network topologies are in use today including star, decentralized star, ring, and distributed networks. The vast confluence of networks commonly referred to as the Internet could accurately be described as a global decentralized network. In today's communication oriented environment, increasingly large numbers of intelligent devices such as personal computers (“PCs”) and servers are being connected to the Internet. New products and services are emerging that use the network infrastructure as a platform, with web services and peer-to-peer applications vying for market share. Additionally, attempts have been made to bring conventionally “dumb” devices such as telephones and toasters into the network platform. Soon, there will be an enormous number of small, low power, low cost, smart devices such as sensors and other devices that will be network enabled.

One attempt to capitalize on the network infrastructure as a platform is the Jini™ technology advanced by Sun Microsystems. This network technology provides software mechanisms that enable network devices to come together to form an impromptu community. The software mechanisms provided, however, require a complex system of network based lookup services, registering of interfaces, and a Java virtual machine providing Java Remote Method Invocation services on each networked device.

These onerous requirements create a distinct burden on the processor of each host device and actually increases network traffic with the registering, uploading, and downloading of each service interface. Such increased network traffic is a significant barrier to implementation of this technology over a wireless network. In addition, there are no power management or security functions associated with Jini. Furthermore, a lookup service must be maintained or hosted somewhere within the network, causing additional overhead in order to facilitate the formation of an impromptu community of devices offering services.

Other problems are encountered when attempting to integrate conventionally “dumb” devices into a communication network. For example, the cost of adding the necessary communication hardware and software can create design problems and be prohibitively expensive. Additionally, naming and configuration problems are also encountered when attempting to bring the existing and new networked devices together over a distributed network.

Therefore, what is needed is a system and method that efficiently and economically integrates devices into a distributed network platform.

### SUMMARY OF THE INVENTION

The present invention integrates signal processing and communication functions with the native functions of a machine to provide a network based platform for hierarchical information processing. The signal processing and communication functions allow information to be processed at various levels of abstraction, ranging from detailed microscopic examination of specific targets, to high level macroscopic examination of the aggregate behavior of targets. The invention may be implemented as a device that allows machine to machine communication over a communication network.

The device may be implemented as an ASIC, sea of gates, or mask programmed CPU. The device can preferably be placed directly in the communication path between the processor and the physical layer of the host machine. Circuitry and embedded software perform the functions of data traffic management (communications and routing), application hosting, network architecture monitoring and diagnostics, LAN operations, security, machine diagnostics and location mapping. The device is advantageously adaptable to communicate over wired and wireless networks employing any of the various available transport media including phone, bluetooth, Ethernet, and 802.11a/b, just to name a few.

The device may be logically divided into two discrete aspect, a hardware core and a software protocol stack. The hardware core handles the signal processing functions of the invention while the software protocol stack handles the networking protocols and communication functions of the invention. Other variations, configurations, and logical organizations of the invention will become apparent to one having ordinary skill in the art after careful consideration of the detailed description.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example distributed network topology according to an embodiment of the present invention;

FIG. 2 is a block diagram illustrating an example information device according to an embodiment of the present invention;

FIG. 3 is a block diagram illustrating an example placement of a machine to machine communication device according to an embodiment of the present invention;

FIG. 4 is a block diagram illustrating a standard protocol stack according to an embodiment of the present invention;

FIG. 5 is a block diagram illustrating an example functional set of a machine to machine communication device according to an embodiment of the present invention;

FIG. 6 is a block diagram illustrating an example machine to machine communication device according to an embodiment of the present invention;

FIG. 7 is a block diagram illustrating an example communication interface of a machine to machine communication device according to an embodiment of the present invention; and

FIG. 8 is a block diagram illustrating an example software system of a machine to machine communication device according to an embodiment of the present invention.

### DETAILED DESCRIPTION OF THE INVENTION

Certain embodiments as disclosed herein provide for a device integrated with a network enabled machine that relieves the networking overhead from the machine's processor while streamlining network communications. For example, the device may be an application specific integrated circuit (“ASIC”) that is disposed between the physical layer and the processor in the machine. The ASIC can perform the functions of data traffic management, network architecture monitoring and diagnostics, and local machine security, diagnostics, and location mapping.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

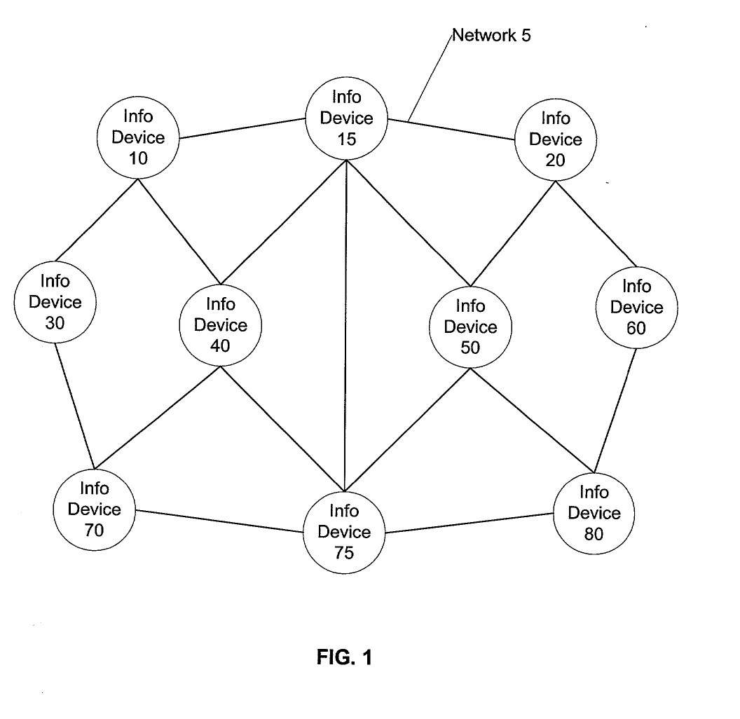

FIG. 1 is a network diagram illustrating an example distributed network 5. The present invention may be employed with various types of network topologies including a distributed topology, star, decentralized star, and ring, just to name a few. In one embodiment, the network environment of the present invention comprises a plurality of information devices such as information devices 10, 15, 20, 30, 40, 50, 60, 70, 75, and 80.

An information device, such as information device 10 can be any of a variety of devices. For example, information device 10 may be a standard PC, a server, a personal digital assistant (“PDA”), a sensor, a pager, a telephone, a cell phone, a wrist watch, an automobile, or any other device for which there is a desire to include communication capabilities. Preferably the various information devices 10-80 are communicatively coupled over network 5.

Network 5 may be a wired or wireless network or some combination of the two. Network 5 may be a personal area network (“PAN”), a local area network (“LAN”), a wide area network (“WAN”), a metropolitan area network (“MAN”), or combination of networks such as, for example, the Internet. Preferably, network 5 supports a variety of wired and wireless communication protocols, including but not limited to: TCP/IP, HTTP, WAP, CDPD, GPRS, 1× RTT, EDGE, and the like.

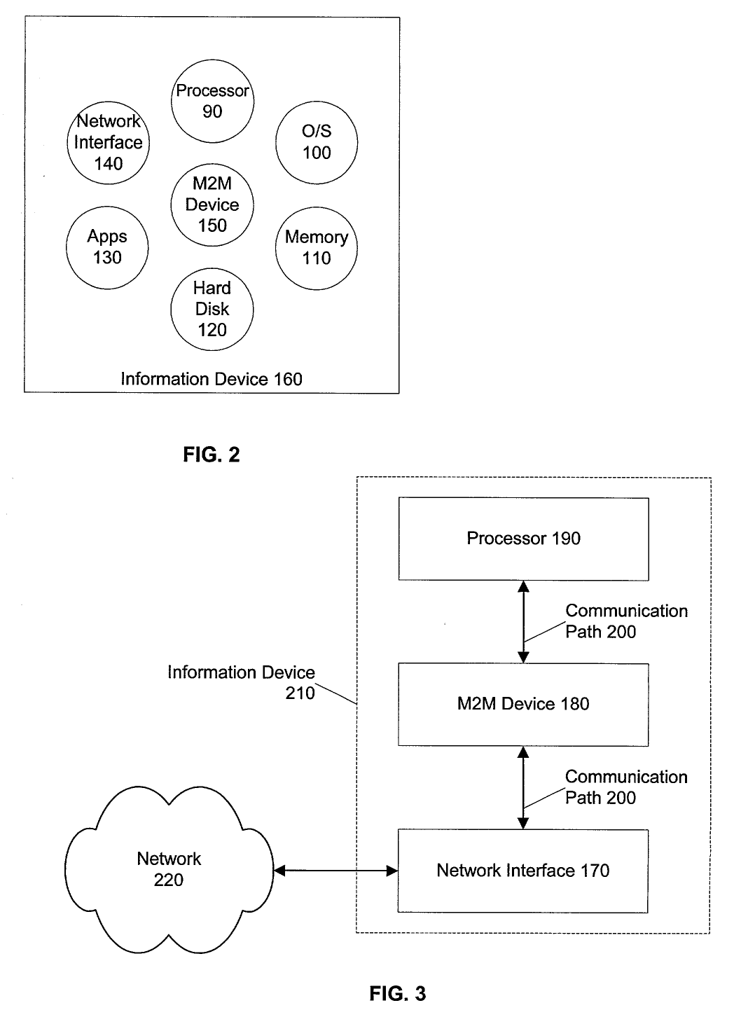

FIG. 2 is a block diagram illustrating an example information device 160. The various different types of information devices connected to the network may have different characteristics and therefore may include all or some subset of the components included in information device 160. Those having skill in the art will understand the varying needs of task specific information devices such as a sensor versus generalist information devices such as a PC.

In one embodiment information device 160 may comprise a processor 90, an operating system 100, a memory 110, a persistent storage medium 120, a suite of software applications 130, a network interface, and a machine to machine communication device (“M2M device”) 150. The processor 90 may be a commercial processor or a specially designed processor for the particular information device 160. Processor 90 may include a plurality of processors that in aggregate comprise processor 90. In one embodiment, the processor may not be present. In such an embodiment, any specific tasks that the information device performs may be carried out by the M2M device 150. For example, the M2M device 150 may provide a platform for device specific software applications to execute, eliminating the need for processor 90.

Information device 160 may also include an operating system 100. The operating system 100 may be a commercial operating system such as Microsoft Windows, MacOS, Linux, PalmOS, or Openwave, just to name a few. Alternatively, operating system 100 may be a proprietary or custom operating system developed for the particular information device 160. For example, many digital cell phones have proprietary operating systems developed by the phone manufacturer.

In one embodiment, the operating system 100 may not be present. In such an embodiment, the tasks carried out by a traditional operating system may be shifted over to the M2M device 150. Advantageously, certain devices with minimal functions may be able to optimize their physical size and overhead by integrating all functions into the M2M device 150. In such an embodiment, the M2M device 150 may provide a platform for device specific software applications to execute, eliminating the need for operating system 100.

Information device 160 may also include a memory 110. Memory 110 may be a conventional memory solution, as will be understood by those having ordinary skill in the art. Information device 160 may also include a persistent storage medium 120. Examples of persistent storage medium 120 include a fixed hard drive, removable disk drive such as a floppy diskette, re-writable CD, removable tape drive, and the like. Preferably, persistent storage medium 120 can be used to store the operating system 100, any applications 130, and any files or databases employed by the information device 160.

Information device 160 may also include a suite of applications 130. These applications may include specific applications that cause the information device 160 to perform its particular task. Alternatively, applications 130 may also include portions of distributed network applications that cause the information device 160 to be part of a distributed, network based operation. Applications 130 running on information device 160 may be stored on the persistent storage device 120, employ memory 110 and be executed by the processor 90 in control of the operating system 100. Alternatively, applications 130 running on information device 160 may be executed and controlled by M2M device 150.

Information device 160 may also include a network interface 140. In one embodiment, network interface 140 may be a wired connection to a communication network. Alternatively, network interface 140 may be a wireless connection to a communication network. Preferably, the function carried out by network interface 140 is to communicatively couple information device 160 with a communication network. That may include establishing a radio link with a wireless network or establishing an electrical link with a wired network.

Information device 160 also includes M2M device 150. M2M device 150 may be implemented in hardware, software, or some combination of hardware and software. M2M device 150 may be implemented as an application specific integrated circuit (“ASIC”), a sea of gates, or a mask programmed CPU.

In one embodiment, M2M device 150 may contain circuitry and embedded software that allow it to perform the function of data traffic management, application hosting, network architecture monitoring and diagnostics, network and device security, device diagnostics, and device location mapping. For example, the data traffic management functions may include processing communications directed to the information device 160 through a protocol stack.

Preferably, in an information device 160 that includes processor 90 and operating system 100, the M2M device 150 offloads the communications responsibilities from the processor 90 and the operating system 100. Advantageously, this may free processing power (i.e. CPU cycles) for use by applications that define the function of the information device 160.

FIG. 3 is a block diagram illustrating an example placement of an M2M device 180 in an information device 210 connected to a communication network 220. In one embodiment, the M2M device 180 can advantageously be placed directly in the communication 200 between the processor 190 and the network interface 170. Preferably, such a placement allows the M2M device 180 to handle all of the communication functions of the information device 210. Advantageously, this allows the processor 190 to be dedicated to other tasks.

In one embodiment, the M2M device 180 may handle data traffic management, application hosting, network architecture monitoring and diagnostics, security, and local diagnostics and network location mapping. For example, the data traffic management function of the M2M device 180 may include routing communications received by the information device 210 that are bound for a foreign destination on the network 220. Additionally, data traffic management functions may include processing communications bound for the information device 210 according to their particular protocol.

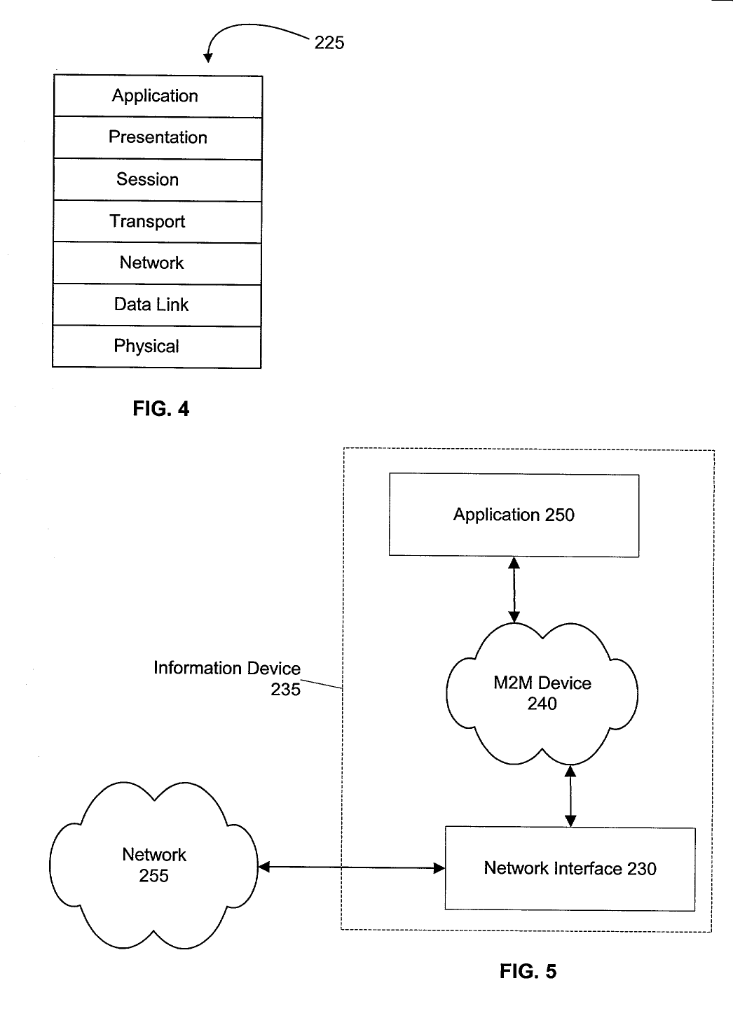

FIG. 4 is a block diagram illustrating a standard protocol stack. At the lowest level of the stack is the physical layer. The physical layer describes the physical interconnection between an information device and the communication network, including the electrical or wireless characteristics. The next layer—the data link layer—specifies how data travels between two information devices, for example by defining a frame that encapsulates the data and by defining any acknowledgements that allow two information devices to know when a frame has been successfully transferred.

The network layer defines the basic unit of transfer across the network and covers the concepts of destination addressing and routing. The unit of transfer may be larger than the frame defined by the data link layer. In such a case, a network layer packet may be broken into several frames for transport across the network. The transport layer provides end-to-end reliability by having the destination host communicate with the source host. This higher level end-to-end reliability allows the transport layer to double check the successful transmission of packets from the source to the destination.

The higher layers include the session layer, the presentation layer, and the application layer. These layers collectively describe how protocol software is organized to handle the functionality needed by application programs. For example, standard methods for converting graphical images into bit streams for transport over the network can typically be found in the presentation layer while network based applications such as email and file transfer programs can be found in the application layer. The session layer is dedicated to issues related to remote access, such as a terminal and server environment.

Alternative protocol stacks may also be employed by the present invention. In one embodiment, the session and presentation layers may be eliminated from a protocol stack that serves an information device that does not allow remote access or does not have a visual interface. For example, a sensor device may employ a protocol stack that does not have a session layer or a presentation layer.

FIG. 5 is a block diagram illustrating an example functional set of a machine to machine communication device 240 in an information device 235. In one embodiment, the information device 235 has a network interface 230 that is communicatively coupled with a network 255. The network 255 may be a wired or wireless network. Information device 235 also includes application 250. Application 250 may include one or more applications that execute on the processor of information device 235. Alternatively, application 250 may include one or more applications that execute on M2M device 240.

Advantageously, the M2M device 240 may be physically placed in the communication path between the network interface 230 and the processor (not pictured) of the information device 235. Additionally, regardless of the physical placement, the M2M device 240 may be logically placed between the network interface 230 and the application 250 that runs on the information device 235. Although various applications may run the information device 235, for easier comprehension, the present description will refer to the various applications collectively and singularly.

In one embodiment, all communications received from the network 255 pass through the network interface 230 and are processed by the M2M device 240. The M2M device 240 may route the communication to another device on network 255 or process the communication for local distribution to application 250. Preferably, the M2M device 240 may handle all of the communication functions of the information device 235.

For example, M2M device 240 may perform the functions data traffic management, including the processing of communications and routing. M2M device 240 may also perform the functions of application hosting such as providing the execution platform for a software application that runs on the M2M device 240. M2M device 240 may also perform certain LAN operations such as replicating and maintaining routing tables, as one example. M2M device 240 may also handle security for network access and provide local machine diagnostics for M2M device 240.

M2M device 240 may also perform location mapping services relating to the logical and physical location of peer or other device on the network 255. For example, the physical location may pertain to the relative positioning of individual sensors in an array of sensors. Alternatively, it may pertain to the relative location of individual satellite dishes in an array of dishes. Logically, M2M device 240 may perform location mapping services relating to the distance, in number of hops for example, for each of the various other devices on the network.

The M2M device 240 may also perform the functions of network architecture monitoring and diagnostics. For example, the M2M device 240 may query the network for the presence of other devices, applications, or application modules. M2M device 240 may also passively receive communications describing the state of the network, for both architectural and diagnostic purposes. Advantageously, M2M device 240 may compile this information to maintain and monitor the status of the architecture of network 255. Such a function may be particularly useful when network 255 is a wireless communication network. Additionally, M2M device 250 may compile this information to monitor the health of the network 255 and provide diagnostic information relating to the network 255.

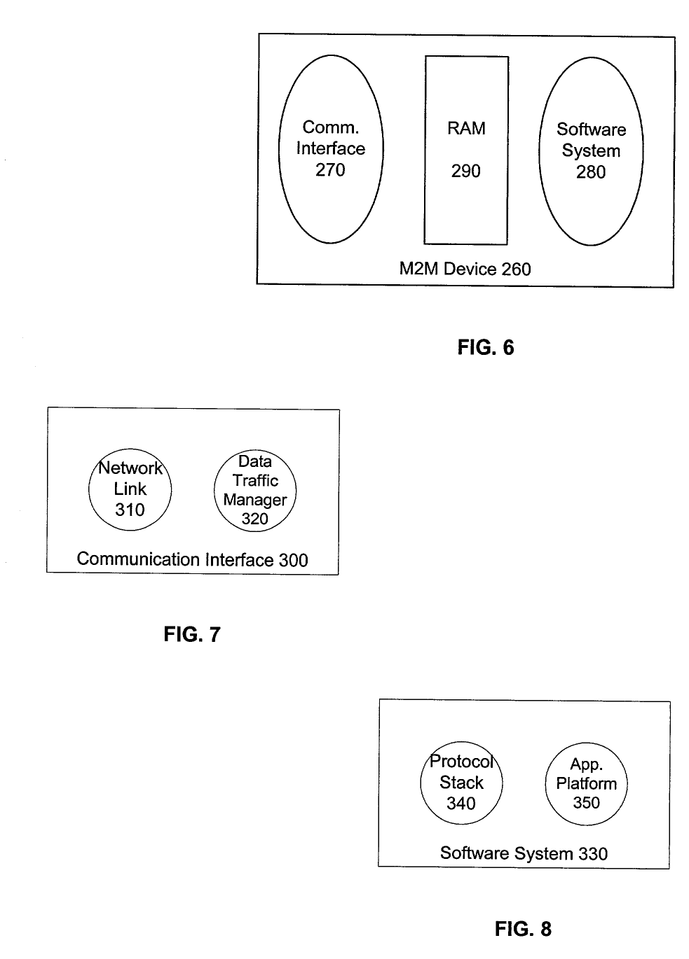

FIG. 6 is a block diagram illustrating an example M2M device 260. In one embodiment, M2M device 260 may be comprised of a plurality of components including a communication interface 270, a software system 280 and a memory 290. Preferably, the communication interface 270 performs the communications related functions of the M2M device 260. For example, the communication interface 270 may send communications to and receive communications from the network interface of the information device (not pictured).

The software system 280 preferably provides an execution platform for software applications to run on the information device. For example, an application may be optimized to execute on the M2M device 260. The software system 280 advantageously may be called upon to manage the execution of such an application. Additionally, software system 280 may comprise the entire operating system for M2M device 260 and also for the information device itself.

Another function of software system 280 may include the processing of communications received from the network through a corresponding protocol stack. This function may advantageously serve to provide network based distributed applications with the appropriate communications from the various and dispersed modules that comprise the application.

M2M device 260 also comprises a memory 290. Memory 290 may be implemented in various formats including random access memory, read only memory, dynamic random access memory. Other types of off the shelf and customized memory modules may also be employed, as will be understood by those having ordinary skill in the art. Preferably, memory 290 may perform the function of buffering incoming and outgoing communications. For example, memory 290 may store individual packets that make up a network communication, allowing M2M device 260 to reassemble the network communication.

FIG. 7 is a block diagram illustrating an example communication interface 300 in an M2M device (not pictured). In one embodiment, communication interface 300 may be comprised of a network link 310 and a data traffic manager 320. Preferably, network link 310 is communicatively coupled with the network interface of the information device. Advantageously, the network link 310 is adaptable to communicate with a wireless network or a wired network.

Data traffic manager 320 preferably performs the function of routing and processing communications received by the information device. For example, when a communication is received by the information device, data traffic manager 320 may determine the destination of the communication. If the destination is not the local information device, data traffic manager 320 advantageously may route the communication to the appropriate network for ultimate delivery. Alternatively, data traffic manager 320 may discard communications not bound for the local information device. Also, data traffic manager 320 may process those communications that are received and destined for the local information device by passing those communications to the software system.

FIG. 8 is a block diagram illustrating an example software system 330 of an M2M device (not pictured). Software system 330 may perform specific functions according to the utility of the particular information device it serves. Additionally, software system 330 may perform all of the necessary functions of an operating system for the information device.

In one embodiment, software system 330 may comprise a protocol stack 340 and an application platform 350. The protocol stack 340 preferably receives communications from the communication interface and determines the appropriate protocol or application to process the particular communication. Advantageously, this function provided by the protocol stack 340 may eliminate the need for a traditional operating system to process communications through a protocol stack. Alternatively, if the software system 330 of the M2M device replaces entirely the operating system of the information device, then this function advantageously handles all of the communication processing required by the information device.

The application platform preferably provides the control functions necessary to allow applications to run on the M2M device. For example, a distributed network application may have various peer modules (or master slave modules) working in concert on various information devices located on a communication network. One of the peer modules may execute on the M2M device, under the control of the application platform 350. Furthermore, application platform 350 may allow a plurality of applications to execute contemporaneously, handling the division of processor cycles according to various schedules, preferably an optimized schedule for the particular processor in use or the particular M2M device in use.

While the particular systems and methods for machine to machine communication herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A device for providing machine to machine communication over a communication network, the device comprising:
a communication interface having a network link and a data traffic manager, the communication interface adaptable to receive communications from a communication network and to provide communications to the communications network;
a software system having a protocol stack and an application platform, the software system adaptable to process communications received from the communication interface and provide communications to the communication interface; and
a memory adaptable to temporarily buffer communications.

2. The device of claim 1, wherein the device is assembled in an application specific integrated circuit.

3. The device of claim 1, wherein the communication network is a wireless network.

4. The device of claim 1, wherein the communication interface further comprises:
a network link in electrical communication with the communication network; and
a data traffic manager configured to route communications over the communication network.

5. The device of claim 4, wherein the network link is in radio communication with the communication network.

6. The device of claim 1, wherein the software system further comprises:
a protocol stack adaptable to process communications conforming to a plurality of communication protocols; and
an application platform adaptable to execute a software application.

7. A computer system including a processor, a volatile storage area, a communication means, and a machine to machine communication device, the machine to machine communication device configured to send and receive communications over a network, route traffic on the network, process communications bound for the computer system, and host applications on the computer system.

8. The computer system of claim 7, wherein the network is a wireless network.

9. The computer system of claim 7, wherein communications bound for the computer system are processed through a protocol stack implemented by the machine to machine communication device.

10. A method for facilitating machine to machine communication over a communication network, comprising:
receiving a communication from a communication network;
providing the communication to an application specific integrated circuit,
wherein the application specific integrated circuit performs the following steps:
determining the destination of the communication;
processing locally bound communications; and
forwarding remotely bound communications to the communication network.

11. The method of claim 10, wherein the processing step further comprises:
determining a type for the communication;
providing the communication to a protocol module associated with the type; and
processing the communication at the protocol module.
